(19) United States
(12) Patent Application Publication
(10) Pub. No.: US 2022/0354147 A1
(43) Pub. Date: Nov. 10, 2022

(54) GRANULATION OF EGG POWDER

(71) Applicant: Arkion Life Sciences, LLC, New Castle, DE (US)

(72) Inventors: Shawn Jones, Bear, DE (US); Emily Hudson, Middletown, DE (US); Earnest W. Porta, Landenberg, PA (US); Samuel V. Walker, Elkton, MD (US)

(73) Assignee: Arkion Life Sciences, LLC, New Castle, DE (US)

(21) Appl. No.: 17/738,583

(22) Filed: May 6, 2022

Related U.S. Application Data
(60) Provisional application No. 63/186,296, filed on May 10, 2021.

(51) Int. Cl. A23K 10/20; A23K 40/10; A23K 20/163

(52) U.S. Cl. CPC A23K 10/20; A23K 40/10; A23K 20/163

(57) ABSTRACT

The present disclosure is directed to methods of producing egg granules comprising spray drying an egg comprising one or more antibodies to produce a low moisture egg powder; and dry granulating the low moisture egg powder to produce egg granules comprising the one or more antibodies. The present disclosure also relates to egg granule having a diameter in a range of about 0.70 mm to about 5.00 mm, wherein the egg granule comprises one or more antibodies.

### CROSS-REFERENCE TO RELATED APPLICATIONS

This application claims the benefit of U.S. Provisional Application No. 63/186,296, filed May 10, 2021, which is incorporated herein, in its entirety, by reference.

### FIELD

The present disclosure relates to spray drying and dry granulation methods of granulating and pelleting egg powders.

### BACKGROUND

The majority of animal feeds are delivered as pellets. To generate pelleted feed, the feed mash is first conditioned with steam and then pressed through a die under pressure to form the pellets. Finally, the pellets are cooled with forced air. A typical conditioning temperature is 160° F. (71.11° C.), though some feeds use higher temperatures (up to 185° F. (85.00° C.)) or lower temperatures (down to 125° F. (51.67° C.)). The combination of heat, pressure, and moisture during the conditioning can have a negative impact on biological additives to the feed, such as antibodies, peptides, and other proteins, causing them to denature or lose their specific binding activities.

Chickens produce in their eggs the highest level of immune products found anywhere in nature. Normally hens transfer immunities to chicks through antibodies and immuno-regulatory factors contained in their eggs. These antibodies are the result of the hens' exposure to antigens. Although, the total amount of antibodies in the egg is relatively constant, it is possible to change the profile by vaccinating against selected antigens; e.g., bacteria, viruses, proteins, etc. This natural process increases the level of target antibodies and immunoregulatory factors already present in the egg. When spray-dried, the egg product (e.g., EggTek™ egg protein additive, Arkion Life Sciences LLC, New Castle, Del.) can be used directly or blended with other products to provide passive immunity and immune support when consumed by humans or animals.

Feeding of spray dried egg powder to animals is an inefficient process as it is difficult to find ways to get animals to ingest the egg powder. Typically, the egg powder is added to normal feed, but in the end, a fair amount of egg powder ends up falling through the feed to the bottom of the feed bins and is never ultimately ingested by the animals. Pelleting of animal feed is a common process for placing feed ingredients into a readily ingestible form. In the case of egg powder, however, standard pelletization processes result in significant loss of antibody activity from the egg powder.

Dry granulation is a process to granulate a powder material without the use of liquid solutions, in contrast to wet granulation or agglomeration. Dry granulation works by compacting the powder particles together until a granule is formed. The two most common methods of dry granulation are slugging and roll compacting. For slugging, the powder is compressed into large flat tablets or pallets using a heavy-duty press, such as a tablet press or a rotary press. For roll compacting, the powder is compressed between two counter-rotating rollers to produce a sheet of solids. After either slugging or roll compacting, the material is milled and screened through meshes to obtain the desired granule size. Granules too small or too large are returned to the beginning of the process to be granulated again. Machines used for roll compaction are commonly called chilsonators, thus the generated material can be referred to as chilsonated material.

There remains a need to produce animal feeds comprising granules or pellets that maintain a substantial antibody activity.

### SUMMARY

One aspect is for a method of producing egg granules comprising: (a) spray drying an egg comprising one or more antibodies to produce a low moisture egg powder; and (b) dry granulating the low moisture egg powder to produce egg granules comprising the one or more antibodies.

In some embodiments, the egg is a hyperimmunized egg.

In some embodiments, the egg is an avian egg, and in some embodiments, the avian egg is a chicken egg.

In some embodiments, the one or more antibodies are IgY antibodies.

In some embodiments, the method comprises after step (a) and before step (b) the additional step of adding one or more additives to the low moisture egg powder; in some embodiments, the one or more additives is one or more saccharides; in some embodiments the one or more saccharides is a disaccharide; in some embodiments, the one or more saccharides is a flour or a starch; and in some embodiments, the flour or starch is derived from wheat, rice, potato, corn, tapioca, barley, oat, or a combination thereof. In some embodiments, the one or more additives is one or more binding agents; and in some embodiments, the one or more additives is one or more fat-containing additive.

In some embodiments, the egg granules have a diameter in a range of about 0.70 mm to about 5.00 mm.

In some embodiments, the egg granules have a diameter in a range of about 1.40 mm to about 3.35 mm.

In some embodiments, the egg granules have a diameter in a range of about 2.00 mm to about 4.75 mm.

In some embodiments, the dry granulation of step (b) comprises the steps of: (i) mixing components; (ii) compacting components through a roller or under pressure; (iii) milling the resulting compacted mass to form granules; and (iv) screening the granules for size.

Another aspect is for a food comprising egg granules produced by the aforementioned method.

An additional aspect is for an egg granule having a diameter in a range of about 0.70 mm to about 5.00 mm, wherein the egg granule comprises one or more antibodies.

In some embodiments, the egg granule comprises hyperimmunized egg.

In some embodiments, the egg granule comprises avian egg, and in some embodiments, the avian egg is chicken egg.

In some embodiments, the one or more antibodies are IgY antibodies.

In some embodiments, the egg granules have a diameter in a range of about 1.40 mm to about 3.35 mm.

In some embodiments, the egg granules have a diameter in a range of about 2.00 mm to about 4.75 mm.

In some embodiments, the egg granule further comprises one or more saccharides, one or more fat-containing additives, and/or one or more binding agents; in some embodiments, the one or more saccharides is a flour or a starch; and in some embodiments, the flour or starch is derived from wheat, rice, potato, corn, tapioca, barley, oat, or a combination thereof.

A further aspect is for a food comprising the aforementioned egg granule.

Other objects and advantages will become apparent to those skilled in the art upon reference to the detailed description that hereinafter follows.

### BRIEF DESCRIPTION OF THE DRAWINGS

FIG. 1 shows a general schematic of the roll compaction dry granulation process.

FIG. 2 shows total IgY from mash and cooled pellet using a conditioning temperature of 125° F. (51.67° C.). Total IgY was determined for the dry mash and the cooled pellets from each hyperimmunized egg material. Bolded number are the percentage of IgY survival for each egg material between the dry mash and the cooled pellet.

FIG. 3 shows total IgY from mash and cooled pellet using a conditioning temperature of 145° F. (62.78° C.). Total IgY was determined for the dry mash and the cooled pellets from each hyperimmunized egg material. Bolded number are the percentage of IgY survival for each egg material between the dry mash and the cooled pellet.

FIG. 4 shows total IgY from mash and cooled pellet using a conditioning temperature of 160° F. (71.11° C.). Total IgY was determined for the dry mash and the cooled pellets from each hyperimmunized egg material. Bolded number are the percentage of IgY survival for each egg material between the dry mash and the cooled pellet.

FIG. 5 shows total IgY from mash and cooled pellet using a conditioning temperature of 170° F. (76.67° C.). Total IgY was determined for the dry mash and the cooled pellets from each hyperimmunized egg material. Bolded number are the percentage of IgY survival for each egg material between the dry mash and the cooled pellet.

FIG. 6 shows total IgY from mash and cooled pellet using a conditioning temperature of 145° F. (62.78° C.). Total IgY was determined for the dry mash and the cooled pellets from each hyperimmunized egg material. Bolded numbers are the percentage of IgY survival for each egg material between the dry mash and the cooled pellet.

FIG. 7 shows total IgY from mash and cooled pellet using a conditioning temperature of 160° F. (71.11° C.). Total IgY was determined for the dry mash and the cooled pellets from each hyperimmunized egg material. Bolded numbers are the percentage of IgY survival for each egg material between the dry mash and the cooled pellet.

FIG. 8 shows total IgY from mash and cooled pellet using a conditioning temperature of 175° F. (79.44° C.). Total IgY was determined for the dry mash and the cooled pellets from each hyperimmunized egg material. Bolded numbers are the percentage of IgY survival for each egg material between the dry mash and the cooled pellet.

FIG. 9 shows total IgY from mash and cooled pellet using a conditioning temperature of 190° F. (87.78° C.). Total IgY was determined for the dry mash and the cooled pellets from each hyperimmunized egg material. Bolded numbers are the percentage of IgY survival for each egg material between the dry mash and the cooled pellet.

### DETAILED DESCRIPTION

Applicants have solved the stated problem. Applicants have found that dry granulation or direct compaction of a spray-dried egg powder containing antibodies helps the antibodies maintain their specific binding activity under pelleting conditions. In particular, dry granulating a spray-dried egg powder into granules imparts protection to the IgY antibodies within the egg powder from a variety of external, degradative forces.

Dry granulation involves compacting the spray-dried egg powder together at ambient temperature to form granules without the need for moisture (compared to wet granulation or agglomeration). A binder can be used but is not necessary. In some embodiments, roll compaction can be used to form egg granules. Roll compaction works by passing the powder through two rollers that compacts the powder together into a ribbon. This ribbon is then milled and the granules are screened for the correct size.

In some embodiments, other dry granulation methods such as direct compaction can be used to produce egg granules.

One benefit of dry granulation of the egg powder is protection during the feed pelletization process. To manufacture feed pellets, the feed components are first mixed together into a mash. The mash is a mixture of all the granular and powder components in the feed. The mash is then fed into a conditioner that injects steam into the mash to produce conditioned mash. The conditioned mash is then fed into a die to form the actual pellets, which are then cooled before packaging.

Wet heat (i.e., steam) causes the IgY in egg powder to degrade (Bobeck et al., Wis. J. Sci. 1:25-28 (2005)). During the pelleting process, steam injected into the conditioner followed by forcing the conditioned mash through the die (generating more heat) causes significant IgY degradation. When the granulated egg powder is used instead of the spray-dried egg powder, significantly improved survival of the IgY is seen. IgY survival is calculated by first determining the amount of IgY in the beginning mash and the amount of IgY in the final pellet by ELISA. For ELISA to work, the IgY must be intact and functional. If the IgY is degraded, it will not be detected by ELISA. Survival is then calculated by dividing the amount of IgY in the pellet by the amount of IgY in the mash.

Another benefit of the present dry granulated egg powder is a potential increase in survivability within the gastrointestinal (GI) tract. As IgY travels down the GI tract, it is exposed to degradative forces and eventually degrades. These degradative forces are primarily enzymes, rather than heat. This could allow the IgY to be functional in the lower GI tract. Several diseases are specific to the lower GI tract, for example blackhead disease in poultry comes about from Histomonas growth in the cecum. The dry granulated egg powder may be able to survive to reach the cecum where it could be functional against the Histomonas.

### Definitions

In this disclosure, a number of terms and abbreviations are used. The following definitions are provided.

As used herein, the term “about” or “approximately” means within 20%, 19%, 18%, 17%, 16%, 15%, 14%, 13%, 12%, 11%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1% or less of a given value or range.

The term “comprising” is intended to include embodiments encompassed by the terms “consisting essentially of” and “consisting of”. Similarly, the term “consisting essentially of” is intended to include embodiments encompassed by the term “consisting of”.

The indefinite articles “a” and “an”, as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or, when used in the claims, “consisting of”, will refer to the inclusion of exactly one element of a number or list of elements. In general, the term “or” as used herein shall only be interpreted as indicating exclusive alternatives (i.e., “one or the other but not both”) when preceded by terms of exclusivity, “either”, “one of”, “only one of”, “exactly one of”. “Consisting essentially of”, when used in the claims, shall have its ordinary meaning as used in the field of patent law.

The term “hyperimmunization” means exposure to one or more antigens such that an immune response is elevated and maintained above the natural unexposed state.

A “hyperimmune state” refers to an elevated immune response in an egg producing animal that has been hyperimmunized.

The term “egg” as used herein refers to a whole egg (table, hyperimmunized or otherwise). The term “egg product” as used herein refers to a whole egg or any product or fraction obtained from a whole egg. In a particular embodiment, the egg product is an egg yolk, for example, an egg yolk powder. In another embodiment, the egg product is an egg white, for example, an egg white powder. In another embodiment, the egg product is obtained from a whole egg, for example, a whole egg powder (e.g., a spray-dried whole egg powder).

The term “hyperimmunized egg” refers to a whole egg obtained from an egg-producing animal maintained in a hyperimmune state, i.e., an egg-producing animal that has been hyperimmunized. The term “hyperimmunized egg product” refers to a hyperimmunized egg or any product obtained from a hyperimmunized egg. In certain embodiments, the hyperimmunized egg product is a concentrate. As used herein the term “concentrate” refers to a hyperimmunized egg product that is at least partially purified, such that the concentration of antibodies in the concentrate is greater than the concentration of antibodies in a hyperimmunized egg. In some embodiments, the hyperimmunized egg product is an aqueous IgY concentrate. The term “aqueous IgY concentrate” as used herein refers to an aqueous solution comprising IgY antibodies isolated from a hyperimmunized egg, wherein the concentration of IgY antibodies in the aqueous solution is higher than the concentration of antibodies in the hyperimmunized egg. Hyperimmunized eggs are described in more detail in, e.g., U.S. Pat. No. 10,450,364, incorporated by reference herein in its entirety.

The term “egg powder” refers to a whole egg that has been dried. In some embodiments, the egg powder is spray-dried.

The term “egg-producing animal” means any oviparous animal, and includes any animal that lays an egg, such as avians, fish, and reptiles.

The term “avian” refers to an animal that is a member of the class Ayes. Avians include, but are not limited to, chickens, turkeys, geese, ducks, pheasants, quail, pigeons, and ostriches.

The term “supranormal levels” means levels in excess of those found in eggs of egg-producing animals that are not hyperimmunized. For example, supranormal levels of an antibody to a particular antigen are levels of the antibody in excess of those found in eggs of egg-producing animals that are not hyperimmunized with the particular antigen.

The phrase “egg granules” as used herein refers to granules derived from spray-dried egg powder followed by dry granulation.

As used herein, an “antibody” is a protein that includes at least one complementary determining region that binds to a specific target antigen, e.g., antigen A, B, C, D, Co1, Co2, H, or ET-50 disclosed herein. For example, an antibody can include a heavy (H) chain variable region (abbreviated herein as VH), and a light (L) chain variable region (abbreviated herein as VL). In another example, an antibody includes two heavy (H) chain variable regions and two light (L) chain variable regions. In a particular embodiment, the antibody is a polyclonal antibody. The term “polyclonal antibody”, as used herein, refers to a population of antibody molecules that that are capable of immunoreacting with different epitopes on a particular antigen. In a particular embodiment, the antibody is an IgY antibody.

The term “survivability” as used herein refers to percent retention of antibody activity after passing through a process and is calculated by determining the amount of antibody activity in the starting material (i.e., before passing through the process) and in the final material (i.e., after passing through the process). Processes can include, but are not limited to, spray drying, dry granulation, or pelletization.

The term “food product” encompasses any consumable matter of either plant or animal origin or of synthetic sources that contain a body of nutrients such as a carbohydrate, protein, fat vitamin, mineral, etc. The product is intended for the consumption by humans or by animals, such as domesticated animals, for example cattle, horses, pigs, sheep, goats, and the like; and pets such as dogs, cats, rabbits, guinea pigs, mice, rats, birds (for example chickens or parrots), reptiles and fish (for example salmon, tilapia or goldfish) and crustaceans (for example shrimp). In some embodiments, the subject matter described herein includes standard food products pelleted feeds and pet food (for example a snack bar, crunchy treat, cereal bar, snack, biscuit, pet chew, pet food, and pelleted or flaked feed for aquatic animals).

### Methods of Producing Egg Granules

The present disclosure includes methods which comprise spray drying an egg comprising one or more antibodies to produce a low moisture egg powder and dry granulating the low moisture egg powder to produce egg granules comprising the one or more antibodies.

The process of spray drying eggs is well known in the art and may be carried out, for example, as described generally in the “Spray-drying Handbook”, 5^{th} ed., K. Masters, John Wiley & Sons, Inc., NY, N.Y. (1991); Platz et al. (WO 97/41833 and WO 96/32149); Cal et al., J. Pharma. Sci. 99:575-86 (2010); Sollohub et al., J. Pharma. Sci. 99:587-97 (2010). Conventional spray driers, such as those available from commercial suppliers such as Niro A/S (Denmark), Mali (Switzerland) and the like, can be used to spray dry egg powders disclosed herein. Optimal conditions for spray-drying the egg powders will vary depending upon the egg used and the presence of any other components such as adjuvants, and are generally determined experimentally.

Dry granulation is a method of controlled crushing of precompacted powders densified by either slugging or passing the material between two counter-rotating rolls. More specifically, powdered components that may contain very fine particles are typically mixed prior to being compacted to yield hard slugs which are then ground and sieved before the addition of other ingredients and final compression to form tablets. Because substantially no liquids are used in the dry granulation process, the issues related to wet granulation are avoided. Known dry granulation methods are summarized, e.g., in Kleinebudde, Eur. J. Pharm. Biopharm. 58:317-26 (2004). U.S. Pat. No. 6,752,939 (incorporated by reference herein in its entirety) teaches a method and an apparatus for predicting the suitability of a substance for dry granulation by roller compaction using small sample sizes.

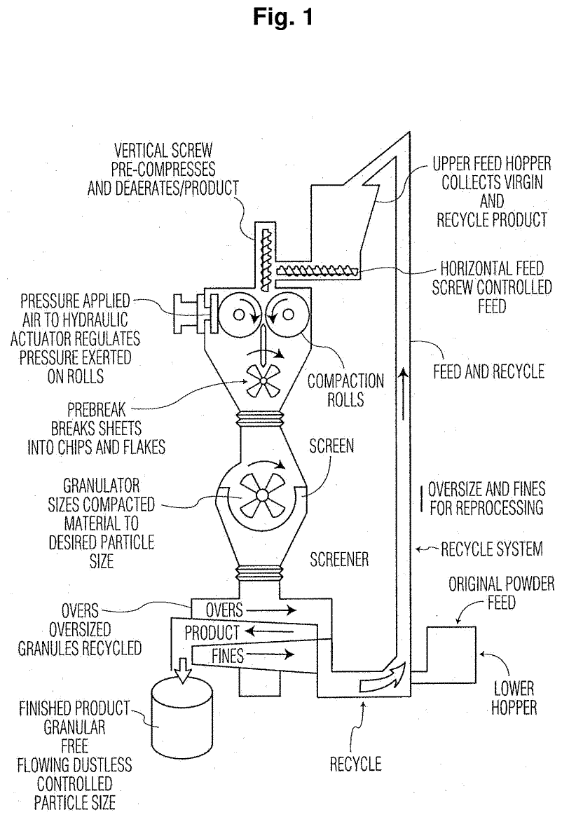

FIG. 1 shows a generalization of an embodiment of the dry granulation step. Low moisture egg powder is initially fed into the upper feed hopper and conveyed to the compaction rollers via a horizontal feed screw followed by a vertical feed screw. As the solid sheets are formed from roll compaction, they are milled using first a prebreak followed by a granulator. The resulting granules are passed through two screens to selected the desired granule size. Overs (granules too large) and fines (granules too small) are recycled via the recycle system back to the upper feed hopper. Granules that pass through the screens are placed in the finished product bin.

In some embodiments, the egg granule may be prepared by roller compression with a compaction granulator such as a roller compactor. The roll pressure varies depending on powder physical properties, and is in some embodiments 1 to 30 MPa, and in some embodiments 10 to 15 MPa. The rotation speed of the roll is, in some embodiments, 1 to 50 rpm, and in some embodiments 2 to 20 rpm. The rotation speed of the screw is, in some embodiments, 1 to 100 rpm, and in some embodiments 2 to 50 rpm.

In some embodiments, egg granules produced by a method disclosed herein can have a diameter in a range of about 0.75 mm to about 5.00 mm, about 0.80 mm to about 4.80 mm, about 0.85 mm to about 4.60 mm, about 0.90 mm to about 4.40 mm, about 0.95 mm to about 4.20 mm, about 1.00 mm to about 4.00 mm, about 1.05 mm to about 3.90 mm, about 1.10 mm to about 3.80 mm, about 1.15 mm to about 3.70 mm, about 1.20 mm to about 3.60 mm, about 1.25 mm to about 3.50 mm, about 1.30 mm to about 3.45 mm, about 1.35 mm to about 3.40 mm, about 1.40 mm to about 3.35 mm, about 1.45 mm to about 3.30 mm, about 1.50 mm to about 3.25 mm, about 1.55 mm to about 3.35 mm, about 1.60 mm to about 3.20 mm, about 1.65 mm to about 3.15 mm, about 1.70 mm to about 3.10 mm, about 1.75 mm to about 3.05 mm, about 1.80 mm to about 3.00 mm, about 1.85 mm to about 2.95 mm, about 1.90 mm to about 2.90 mm, about 1.95 mm to about 2.85 mm, about 2.00 mm to about 2.80 mm, about 2.05 mm to about 2.75 mm, about 2.10 mm to about 2.70 mm, about 2.15 mm to about 2.65 mm, about 2.20 mm to about 2.60 mm, about 2.25 mm to about 2.55 mm, about 2.30 mm to about 2.50 mm, about 2.35 mm to about 2.45 mm, about 0.75 mm to about 4.00 mm, about 0.75 mm to about 3.00 mm, about 0.75 mm to about 2.50 mm, about 0.75 mm to about 2.25 mm, about 0.75 mm to about 2.00 mm, about 0.75 mm to about 1.90 mm, about 0.75 mm to about 1.80 mm, about 0.80 mm to about 1.75 mm, about 0.85 mm to about 1.70 mm, about 1.00 mm to about 5.00 mm, about 1.10 mm to about 5.00 mm, about 1.20 mm to about 5.00 mm, about 1.30 mm to about 5.00 mm, about 1.40 mm to about 5.00 mm, about 1.50 mm to about 5.00 mm, about 1.60 mm to about 5.00 mm, about 1.70 mm to about 5.00 mm, about 1.75 mm to about 5.00 mm, about 1.80 mm to about 4.95 mm, about 1.85 mm to about 4.90 mm, about 1.90 mm to about 4.85 mm, about 1.95 mm to about 4.80 mm, or about 2.00 mm to about 4.75 mm.

In some embodiments, the egg granules can be filtered through sieves (e.g., US Mesh screens) to produce granule size ranges. For example, to produce size ranges of about 0.85 mm to about 1.70 mm, egg granules can pass through a US Mesh 12 screen but not a US Mesh 20 screen; to produce size ranges of about 1.40 mm to about 3.35 mm, egg granules can pass through a US Mesh 6 screen but not a US Mesh 14 screen; and to produce size ranges of about 2.00 mm to about 4.75 mm, egg granules can pass through a US Mesh 4 screen but not a US Mesh 10 screen. US Mesh screen sizes are, e.g., as follows: 4-4.75 mm, 5-4.00 mm, 6-3.35 mm, 7-2.80 mm, 8-2.36 mm, 10-2.00 mm, 12-1.70 mm, 14-1.40 mm, 16-1.20 mm, 18-1.00 mm, 20-0.85 mm, 24-0.69 mm, 30-0.56 mm.

In some embodiments, egg granules may be produced through direct compaction. Direct compaction may comprise blending low moisture egg powder with any additives and compressing it directly into a granule.

In some embodiments, the method further comprises the additional step of adding one or more saccharides to the low moisture egg powder. Saccharides include monosaccharides (such as glucose or xylose), disaccharides (such as lactose or trehalose), oligosaccharides (such as fructo-oligosaccharides), and polysaccharides. Polysaccharides include native starches, amylose-rich starches, amylopectin-rich starches, modified starches, maltodextrin, and beta-glucan. The saccharides can be incorporated as purified saccharides or in a mixture, such as flour or starches. Flours or starches can be derived from wheat, rice, potato, corn, tapioca, barley, oat, and others, and combinations thereof. One or more saccharides can be added to the low moisture egg powder at a ratio of, e.g., about 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51, or 50:50 of one or more saccharides to low moisture egg powder in the combination, though higher ratios of one or more saccharides to low moisture egg powder are contemplated herein. The amount of saccharide to low moisture egg powder can also be expressed as a percentage of one or more saccharides and a percentage of low moisture egg powder, e.g., about 1% one or more saccharides and 99% low moisture egg powder, 2% one or more saccharides and 98% low moisture egg powder, 3% one or more saccharides and 97% low moisture egg powder, 4% one or more saccharides and 96% low moisture egg powder, 5% one or more saccharides and 95% low moisture egg powder, 6% one or more saccharides and 94% low moisture egg powder, 7% one or more saccharides and 93% low moisture egg powder, 8% one or more saccharides and 92% low moisture egg powder, 9% one or more saccharides and 91% low moisture egg powder, 10% one or more saccharides and 90% low moisture egg powder, 11% one or more saccharides and 89% low moisture egg powder, 12% one or more saccharides and 88% low moisture egg powder, 13% one or more saccharides and 87% low moisture egg powder, 14% one or more saccharides and 86% low moisture egg powder, 15% one or more saccharides and 85% low moisture egg powder, 16% one or more saccharides and 84% low moisture egg powder, 17% one or more saccharides and 83% low moisture egg powder, 18% one or more saccharides and 82% low moisture egg powder, 19% one or more saccharides and 81% low moisture egg powder, 20% one or more saccharides and 80% low moisture egg powder, 21% one or more saccharides and 79% low moisture egg powder, 22% one or more saccharides and 78% low moisture egg powder, 23% one or more saccharides and 77% low moisture egg powder, 24% one or more saccharides and 76% low moisture egg powder, 25% one or more saccharides and 75% low moisture egg powder, 26% one or more saccharides and 74% low moisture egg powder, 27% one or more saccharides and 73% low moisture egg powder, 28% one or more saccharides and 72% low moisture egg powder, 29% one or more saccharides and 71% low moisture egg powder, 30% one or more saccharides and 70% low moisture egg powder, 31% one or more saccharides and 69% low moisture egg powder, 32% one or more saccharides and 68% low moisture egg powder, 33% one or more saccharides and 67% low moisture egg powder, 34% one or more saccharides and 66% low moisture egg powder, 35% one or more saccharides and 65% low moisture egg powder, 36% one or more saccharides and 64% low moisture egg powder, 37% one or more saccharides and 63% low moisture egg powder, 38% one or more saccharides and 62% low moisture egg powder, 39% one or more saccharides and 61% low moisture egg powder, 40% one or more saccharides and 60% low moisture egg powder, 41% one or more saccharides and 59% low moisture egg powder, 42% one or more saccharides and 58% low moisture egg powder, 43% one or more saccharides and 57% low moisture egg powder, 44% one or more saccharides and 56% low moisture egg powder, 45% one or more saccharides and 55% low moisture egg powder, 46% one or more saccharides and 54% low moisture egg powder, 47% one or more saccharides and 53% low moisture egg powder, 48% one or more saccharides and 52% low moisture egg powder, 49% one or more saccharides and 51% low moisture egg powder, or 50% one or more saccharides and 50% low moisture egg powder, though higher percentages of one or more saccharides and lower percentages of low moisture egg powder are contemplated herein.

In some embodiments, the egg granules can comprise a binding agent. A “binding agent”, as used herein, is an ingredient which helps a mixture hold together or maintain its shape. Non-limiting examples a binding agent are lignosulfonate, cellulose, cellulose-based binders, povidone, povidone-based binders, milled flaxseed, kelp powder, gelatin by-product, and combinations thereof. In some embodiments, the binding agent is present in the egg granules in an amount of about 0.1%, about 0.2%, about 0.3%, about 0.4%, about 0.5%, about 0.6%, about 0.7%, about 0.8%, about 0.9%, about 1%, about 1.25%, about 1.5%, about 1.75%, about 2%, about 2.25%, about 2.5%, about 2.75%, about 3%, about 3.25%, about 3.5%, about 3.75%, about 4%, about 4.25%, about 4.5%, about 4.75%, about 5%, about 5.25%, about 5.5%, about 5.75%, about 6%, about 6.25%, about 6.5%, about 6.75%, about 7%, about 7.25%, about 7.5%, about 7.75%, about 8%, about 8.25%, about 8.5%, about 8.75%, about 9%, about 9.25%, about 9.5%, about 9.75%, or about 10%. In some embodiments, the binding agent is present in the egg granules in a range of about 0.1% to about 10%, about 0.2% to about 9%, about 0.3% to about 7%, about 0.4% to about 6%, about 0.5% to about 5%, about 0.6% to about 4%, about 0.7% to about 3%, about 0.8% to about 2%, about 0.9% to about 2%, about 1% to about 2%, about 0.2% to about 9%, about 0.4% to about 8%, about 0.6% to about 7%, about 0.8% to about 6%, or about 1% to about 5%.

In some embodiments, the egg granules can comprise a fat-containing additive. A “fat-containing additive”, as used herein, is a powdered ingredient with at least 1% fat. Non-limiting examples of a fat-containing additive are whey powder, lecithin powder, fractionalized palm oil, hydrolyzed vegetable oil, and combinations thereof.

In some embodiments, the dry granulating step can be performed at a temperature range of about 60° F. (about 15.6° C.) to about 85° F. (about 29.4° C.), about 65° F. (about 18.3° C.) to about 85° F. (about 29.4° C.), 70° F. (about 21.1° C.) to about 85° F. (about 29.4° C.), 75° F. (about 23.9° C.) to about 85° F. (about 29.4° C.), 80° F. (about 26.7° C.) to about 85° F. (about 29.4° C.), 60° F. (about 15.6° C.) to about 80° F. (about 26.7° C.), 60° F. (about 15.6° C.) to about 75° F. (about 23.9° C.), 60° F. (about 15.6° C.) to about 70° F. (about 21.1° C.), 60° F. (about 15.6° C.) to about 65° F. (about 18.3° C.), 65° F. (about 18.3° C.) to about 80° F. (about 26.7° C.), or 70° F. (about 21.175° C.) to about 75° F. (about 23.9° C.).

In some embodiments, the conditioning temperature during the pelletization process can be performed at a temperature range of about 125° F. (about 51.67° C.) to about 185° F. (about 85.00° C.), about 130° F. (about 54.44° C.) to about 180° F. (about 82.22° C.), about 135° F. (about 57.22° C.) to about 175° F. (about 79.44° C.), about 140° F. (about 60.00° C.) to about 170° F. (about 76.67° C.), about 145° F. (about 62.78° C.) to about 165° F. (about 73.89° C.), or about 150° F. (about 65.57° C.) to about 155° F. (about 68.33° C.).

### Additional Animal Feed Ingredients

In some embodiments, the egg granules produced by a method disclosed herein are formulated as an animal feed or an animal dietary supplement. For example, in one embodiment, the egg granules are integrated into an animal feed or an animal dietary supplement.

In some embodiments, egg granules can be pelleted as part of the animal feed or animal dietary supplement. In such embodiments, the egg granules typically comprise about 0.1%-0.4% of the animal feed or animal dietary supplement, but inclusion rates of 1%, 2%, 3%, 4%, 5%, 6%, 7%, 8%, 9%, or more are possible. In some embodiments, the egg granules comprise less than 0.1% of the animal feed or animal dietary supplement.

Common animal feed and/or animal dietary supplement components, for example, can include one or more of the following ingredients in addition to egg granules disclosed herein: corn meal, dehulled soybean meal, wheat middlings, limestone, monocalcium-dicalcium phosphate, salt, manganous oxide, manganese sulfate, zinc oxide, ferrous sulfate, copper sulfate, cobalt carbonate, calcium iodate, sodium selenite, one or more vitamins, pyridoxine hydrochloride, folic acid, methionine, soybean oil, mineral oil, amino acids, chicken, calcium, chondroitin, glucosamine, Omega 3 & Omega 6, beet pulp, DHA (from fish oil), beta carotene, fish meal, Vitamin blend, α-linoleic acid, amino acids, arachidonic acid, ascorbic acid, beef, biotin, brewer's yeast (dried), calcium carbonate, cellulose, chelated minerals, chondroitin sulfate, cobalt, copper, corn meal, corn oil, di calcium phosphate, DL-methionine, docosahexaenoic acid, durum flour, ethoxyquin, fat, carbohydrate, ferrous sulfate, fiber, fish meal, fish oil, flax meal, folic acid, fructooligosaccharides, gelatin, glucosamine hydrochloride, glycerin, ground barley, ground corn, ground sorghum, guar gum, inositol, iodine, iron, kangaroo, lamb, 1-carnitine, linoleic acid, lutein, magnesium, magnesium oxide, manganese, marigold extract, mannanoligosaccharides, minerals, mixed tocopherols, monosodium phosphate, niacin, marigold. extract, blueberries, dried kelp, phosphorus, potassium, potassium chloride, potassium iodide, potassium sorbate, protein, pyridoxine hydrochloride, riboflavin, rice, rice flour, rosemary, rosemary extract, tapioca starch, taurine, thiamine mononitrate, titanium dioxide, water, wheat, wheat glutens, xanthan gum, zinc, zinc oxide, zinc sulfate, any of the ingredients presently listed by the Association of American Feed Control Officials, and combinations thereof.

Animal feed and/or an animal dietary supplements can further include any number of optional additional ingredients, including conventional food additives, for example one or more acidulants, additional thickeners, buffers or agents for pH adjustment, chelating agents, colorants, emulsifies, excipient, flavor agent, mineral, osmotic agents, pharmaceutically acceptable carriers, preservatives, stabilizers, sugar, sweeteners, and/or texturizers. The optional ingredients can be added in any suitable amount.

Applicants specifically incorporate the entire contents of all cited references in this disclosure. Further, when an amount, concentration, or other value or parameter is given as either a range or a list of upper values and lower values, this is to be understood as specifically disclosing all ranges formed from any pair of any upper range limit or value and any lower range limit or value, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

### EXAMPLES

### Example 1: Generation of Dry Granulated Material

Hyperimmunized spray-dried powder was dry granulated using a Fitzpatrick 7L×10D Chilsonator. The general operating parameters were an average roll gap of 0.062 inches (0.157 cm) (range was 0.061-0.064 inches (0.155-0.163 cm)) and a roll pressure of 1600-2100 psi (11.03-14.48 MPa). Three granule sizes were generated based on the screens used:

Material 1—0.85 mm to 1.70 mm (generated using US Mesh screens 12 and 20)

Material 2—1.40 mm to 3.35 mm (generated using US Mesh screens 6 and 14)

Material 3—2.00 mm to 4.75 mm (generated using US Mesh screens 4 and 10)

A fourth material was generated where rice flour was added to the hyperimmunized spray-dried egg powder at 20% (i.e., 20% rice flour and 80% spray-dried egg powder) and then dry granulated using US Mesh screens 6 and 14 to generate material 1.40 mm to 3.35 mm in size.

### Example 2: Feed Pellet Generation

An early-stage swine diet was formulated using either hyperimmunized spray-dried powder or one of the dry granulated materials generated in Example 1 (Table 1).

TABLE 1
Swine diet formulation.

| | Amount added |
|---|---|
| Component | (lbs) |
| Corn | 87.97 (39.90 kg) |
| Soybean Meal, Dehull, Sol Extr | 36.20 (16.42 kg) |
| Fish Meal | 9.00 (4.08 kg) |
| Milk, Whey Powder | 50.00 (22.68 kg) |
| HP 300 | 7.50 (3.40 kg) |
| Calcium carbonate | 0.60 (0.27 kg) |
| Calcium phosphate | 0.95 (0.43 kg) |
| (monocalcium) | |
| Sodium chloride | 0.60 (0.27 kg) |
| L-Lysine-HCl | 0.85 (0.39 kg) |
| DL-Methionine | 0.44 (0.20 kg) |
| L-Threonine | 0.36 (0.16 kg) |
| L-Tryptophan | 0.13 (0.06 kg) |
| L-Valine | 0.25 (0.11 kg) |
| Trace mineral premix | 0.30 (0.14 kg) |
| Vitamin premix without phytase | 0.50 (0.23 kg) |
| Ronozyme HiPhos 2700 | 0.15 (0.07 kg) |
| Zinc oxide | 0.80 (0.36 kg) |
| Soy Oil | 3.00 (1.36 kg) |
| Egg powder (granule or spray- | 0.40 (0.18 kg) |
| dry) | |
| | 200.00 (90.72 kg) |

Components were mixed for 30 seconds before conditioning and pelleting. Pellets were produced from mash diets via steam conditioning (5″ (12.7 cm) diameter×36″ (91.44 cm) length) and subsequently using a pellet mill (Model CL5 California Pellet Mill Co., Crawfordsville, Ind.) equipped with a 3/16″ (0.48 cm)×½″ (1.27 cm) die. The diets were conditioned at either 125° F. (51.67° C.) or 145° F. (62.78° C.) for 30 seconds. Pellets were collected in cooling trays as they exited the pellet die and cooled with ambient air for approximately 10 minutes in a counter-flow cooler.

### Example 3: Quantification of IgY in Pelleted Feed

Total IgY was determined in the dry mash (i.e., before steam conditioning) and the cooled pellets (three replicate samples) for each diet and temperature. IgY was extracted by milling 50 g of material (mash or pellet) to a powder, adding milled powder to 200 g of 0.2% (v/v) acetic acid, gently mixing for 30 minutes at room temperature, and then held at 4° C. overnight. The next morning, the samples were mixed and 50 mL was removed and centrifuged to remove the solids. The supernatant was kept and used for IgY quantification. Total IgY was quantified using the Chicken IgY ELISA Kit (Immunology Consultants Laboratory, Inc., Portland, Oreg.) and following the manufacturer's instructions. Three dilutions were made for each sample (1:100, 1:200, and 1:400) and each was run in duplicate. Concentrations are the average between all replicates and dilutions.

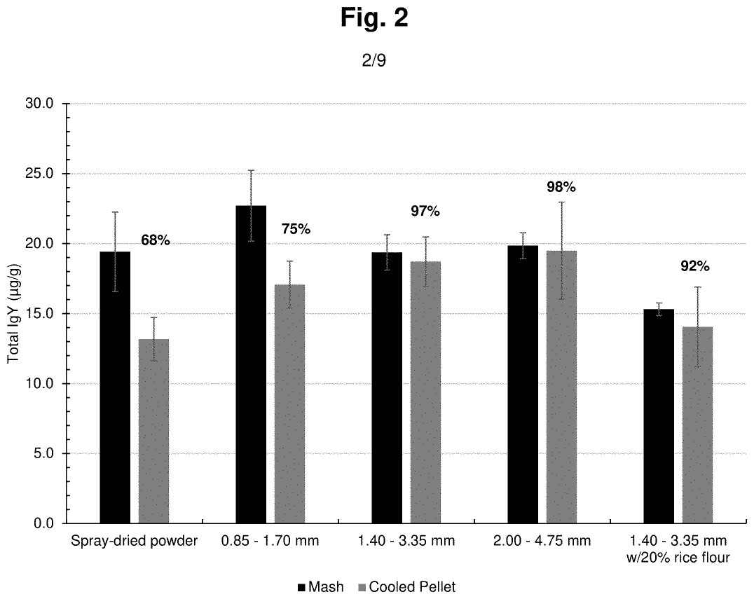

Results from a conditioning temperature of 125° F. (51.67° C.) are shown in FIG. 2 and Table 2.

TABLE 2
Total IgY from conditioning at 125° F. (51.67° C.).

| | | Concentration | |
|---|---|---|---|
| Egg input | Material | (μg) | % Survival |
| Spray-dried powder | Dry Mash | 19.41 (±2.84) | — |
| | Cooled | 13.17 (±1.54) | 68% |
| | Pellet | | |
| Material 1 (0.85-1.70 mm | Dry Mash | 22.70 (±2.53) | — |
| granules) | Cooled | 17.07 (±1.68) | 75% |
| | Pellet | | |
| Material 2 (1.40-3.35 mm | Dry Mash | 19.37 (±1.26) | — |
| granules) | Cooled | 18.71 (±1.76) | 97% |
| | Pellet | | |
| Material 3 (2.00-4.75 mm | Dry Mash | 19.85 (±0.93) | — |
| granules) | Cooled | 19.49 (±3.47) | 98% |
| | Pellet | | |
| Material 4 (1.40-3.35 mm | Dry Mash | 15.31 (±0.45) | — |
| granules with 20% rice flour) | Cooled | 14.05 (±2.85) | 92% |
| | Pellet | | |

Pellets generated from the dry granulated material, even the smallest size of 0.85-1.70 mm, had a greater IgY survival compared to the spray-dried material alone. In addition, as the granule size increased, the percentage of IgY survival also increased.

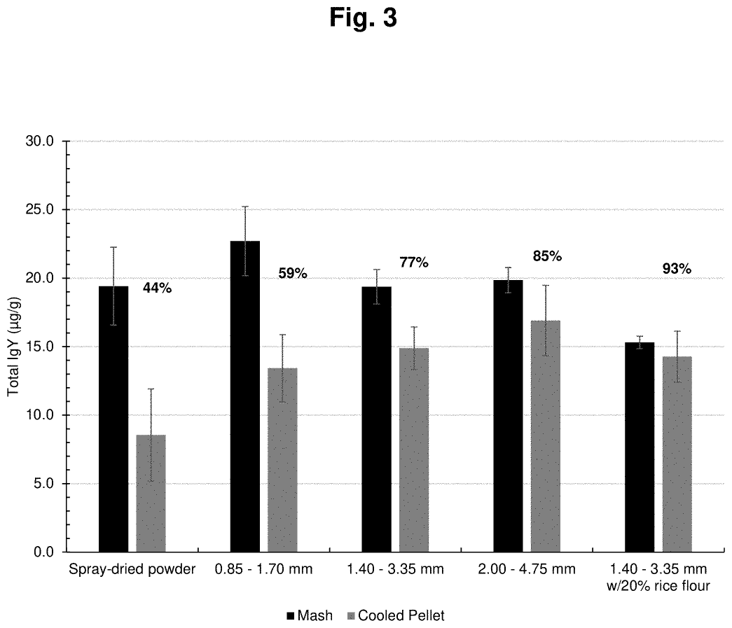

Results from a conditioning temperature of 145° F. (62.78° C.) are shown in FIG. 3 and Table 3.

TABLE 3
Total IgY from conditioning at 145° F. (62.78° C.).

| | | Concentration | |
|---|---|---|---|
| Egg input | Material | (μg) | % Survival |
| Spray-dried powder | Dry Mash | 19.41 (±2.84) | — |
| | Cooled | 8.54 (±3.37) | 44% |
| | Pellet | | |
| Material 1 (0.85-1.70 mm | Dry Mash | 22.70 (±2.53) | — |
| granules) | Cooled | 13.42 (±2.45) | 59% |
| | Pellet | | |
| Material 2 (1.40-3.35 mm | Dry Mash | 19.37 (±1.26) | — |
| granules) | Cooled | 14.89 (±1.55) | 77% |
| | Pellet | | |
| Material 3 (2.00-4.75 mm | Dry Mash | 19.85 (±0.93) | — |
| granules) | Cooled | 16.90 (±2.58) | 85% |
| | Pellet | | |
| Material 4 (1.40-3.35 mm | Dry Mash | 15.31 (±0.45) | — |
| granules with 20% rice | Cooled | 14.27 (±1.87) | 93% |
| flour) | Pellet | | |

The results at 145° F. (62.78° C.) further demonstrate the benefit of dry granulation for retaining IgY activity with the spray-dried powder having only a 44% survival compared to a 59% survival for the smallest granules tested (0.85-1.70 mm) and 85% survival for the largest granules tested (2.00-4.75 mm). When a saccharide was included during dry granulation, in the form of rice flour, the IgY survival increased further, from 77% without the rice flour to 93% with rice flour.

### Example 4: Phase II Swine Diet Pellet Generation

A Phase II nursery swine diet was formulated using either Material 2 (1.40-3.35 mm granules), Material 3 (2.00-4.75 mm granules), or Material 4 (1.40-3.35 mm granules with 20% rice flour) (Table 4).

TABLE 4
Phase II swine diet formulation.

| Component | Amount added (lbs) |
|---|---|
| Corn | 99.88 (45.30 kg) |
| Soybean Meal, Dehull, Sol Extr | 59.33 (26.91 kg) |
| Milk, Whey Powder | 20.00 (9.07 kg) |
| HP 300 | 10.00 (4.54 kg) |
| Calcium carbonate | 2.10 (0.95 kg) |
| Calcium phosphate | 2.10 (0.95 kg) |
| (monocalcium) | |
| Sodium chloride | 0.60 (0.27 kg) |
| L-Lysine-HCl | 0.60 (0.27 kg) |
| DL-Methionine | 0.35 (0.16 kg) |
| L-Threonine | 0.30 (0.14 kg) |
| Trace mineral premix | 0.30 (0.14 kg) |
| Vitamin premix without phytase | 0.50 (0.23 kg) |
| Ronozyme HiPhos 2700 | 0.03 (0.01 kg) |
| Zinc oxide | 0.50 (0.23 kg) |
| Soy Oil | 3.00 (1.36 kg) |
| Egg powder (granule or spray- | 0.40 (0.18 kg) |
| dry) | |
| | 200.00 (90.72 kg) |

Components were mixed for 30 seconds before conditioning and pelleting. Pellets were produced from mash diets via steam conditioning (5″ (12.7 cm) diameter×36″ (91.44 cm) length) and subsequently using a pellet mill (Model CL5 California Pellet Mill Co., Crawfordsville, Ind.) equipped with a 3/16″ (0.48 cm)×½″ (1.27 cm) die. The diets were conditioned at either 160° F. (71.11° C.) or 170° F. (76.67° C.) for 30 seconds. Pellets were collected in cooling trays as they exited the pellet die and cooled with ambient air for approximately 10 minutes in a counter-flow cooler.

### Example 5: Quantification of IgY in Phase II Pelleted Feed

Total IgY was determined in the dry mash (i.e., before steam conditioning) and the cooled pellets (three replicate samples) for each diet and temperature as described in Example 3.

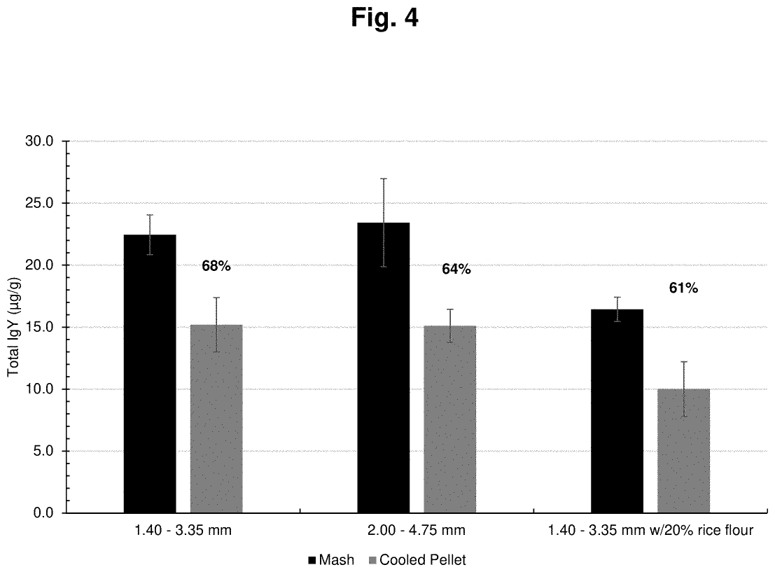

Results from a conditioning temperature of 160° F. (71.11° C.) are shown in FIG. 4 and

Table 5.

TABLE 5
Total IgY from conditioning at 160° F. (71.11° C.).

| | | Concentration | |
|---|---|---|---|
| Egg input | Material | (μg) | % Survival |
| Material 2 (1.40-3.35 mm | Dry Mash | 22.44 (±1.60) | — |
| granules) | Cooled | 15.19 (±2.20) | 68% |
| | Pellet | | |
| Material 3 (2.00-4.75 mm | Dry Mash | 23.42 (±3.55) | — |
| granules) | Cooled | 15.10 (±1.34) | 64% |
| | Pellet | | |
| Material 4 (1.40-3.35 mm | Dry Mash | 16.43 (±0.98) | — |
| granules with 20% rice flour) | Cooled | 10.01 (±2.21) | 61% |
| | Pellet | | |

With the granulated material, IgY survival was around 60% at 160° F. (71.11° C.), compared with a survival of only 44% with spray-dried powder at 145° F. (62.78° C.).

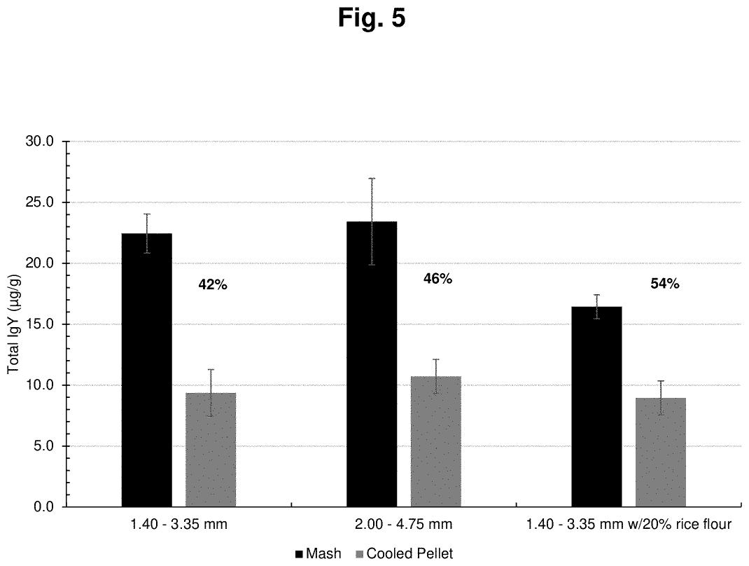

Results from a conditioning temperature of 170° F. (76.67° C.) are shown in FIG. 5 and Table 6.

TABLE 6
Total IgY from conditioning at 170° F. (76.67° C.).

| | | Concentration | |
|---|---|---|---|
| Egg input | Material | (μg) | % Survival |
| Material 2 (1.40-3.35 mm | Dry Mash | 22.44 (±1.60) | — |
| granules) | Cooled | 9.36 (±1.92) | 42% |
| | Pellet | | |
| Material 3 (2.00-4.75 mm | Dry Mash | 23.42 (±3.55) | — |
| granules) | Cooled | 10.72 (±1.40) | 46% |
| | Pellet | | |
| Material 4 (1.40-3.35 mm | Dry Mash | 16.43 (±0.98) | — |
| granules with 20% rice flour) | Cooled | 8.95 (±1.39) | 54% |
| | Pellet | | |

Even at 170° F. (76.67° C.), the largest granulated material (2.00-4.75 mm) and the granulated material with rice four had an IgY survival of 46% and 54%, respectively, compared with the 44% survival of the spray-dried powder at 145° F. (62.78° C.). This demonstrates that granulation significantly improves IgY survival, even at high pelleting temperatures.

### Example 6: Generation of Dry Granulated Material

Hyperimmunized spray-dried powder was dry granulated following the same procedure from Example 1. One granule size was generated using screens US Mesh 6 and 14, yielding granules between 1.40 and 3.35 mm.

Several additives were mixed with the hyperimmunized spray-dried powder before granulation to produce four granulated mixtures:

Material 5—78% egg powder and 22% rice flour

Material 6—76% egg powder, 22% rice flour, and 2% lignosulfonate (brand name Super-Bind®

Material 7—70% egg powder and 30% Cargill Emcap® 06376 starch

Material 8—70% egg powder and 30% Cargill C*Gel® 03420 starch

### Example 7: Generation of Phase I Swine Diet Pellets

The granules produced in Example 6 were formulated into an early-stage swine diet (i.e., Phase I) as described in Example 2. Two conditioning temperatures used were: 145° F. (62.78° C.) and 160° F. (71.11° C.).

### Example 8: Quantification of IgY in Phase I Pelleted Feed

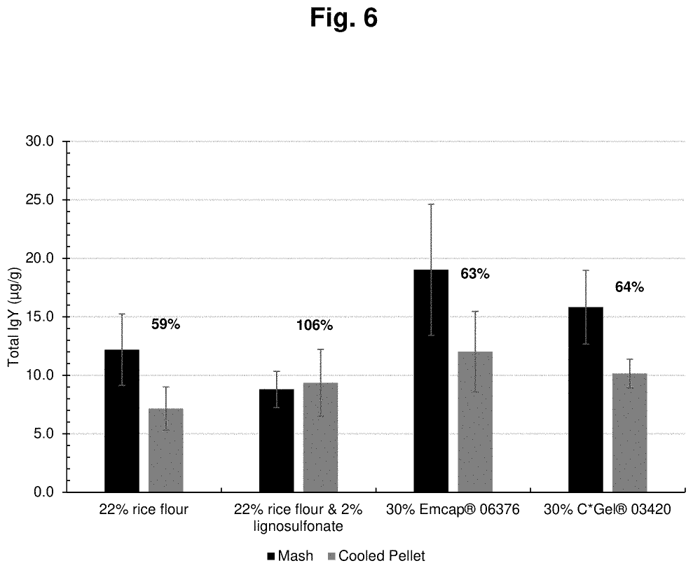

Total IgY was quantified from the feeds generated in Example 7 following the same procedures in Example 3. The results from a conditioning temperature of 145° F. (62.78° C.) are shown in FIG. 6 and Table 7.

TABLE 7
Total IgY from conditioning at 145° F. (62.78° C.).

| | | Concentration | |
|---|---|---|---|
| Egg input | Material | (μg) | % Survival |
| Material 5 (22% rice flour) | Dry Mash | 12.19 (±3.06) | — |
| | Cooled | 7.16 (±1.84) | 59% |
| | Pellet | | |
| Material 6 (22% rice flour & | Dry Mash | 8.80 (±1.54) | — |
| 2% lignosulfonate) | Cooled | 9.35 (±2.86) | 106% |
| | Pellet | | |
| Material 7 (30% Emcap ® | Dry Mash | 19.03 (±5.61) | — |
| 06376) | Cooled | 12.02 (±3.45) | 63% |
| | Pellet | | |
| Material 8 (30% C*Gel ® | Dry Mash | 15.83 (±3.15) | — |
| 03420) | Cooled | 10.15 (±1.23) | 64% |
| | Pellet | | |

Surprisingly, addition of the pellet binder lignosulfonate significantly improved the IgY survival through the pelleting process, increasing from 59% survival with only rice flour to 106% with rice flour and lignosulfonate. The two Cargill starches tested marginally improved IgY survival from 59% with rice flour to 63% and 64%.

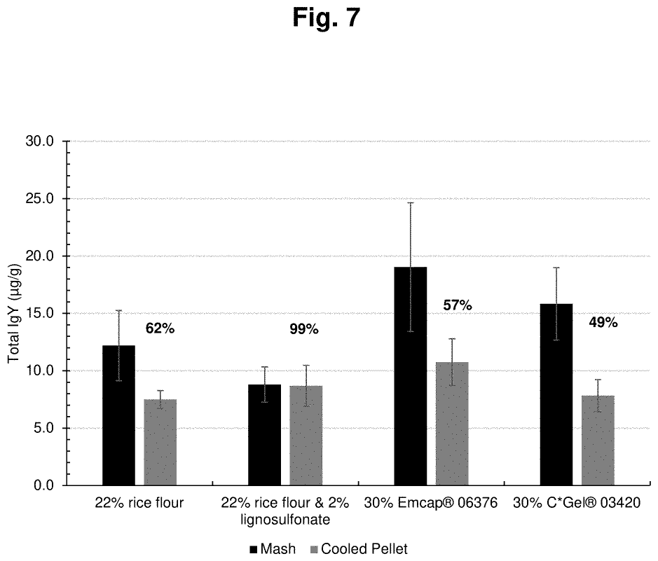

The results from a conditioning temperature of 160° F. (71.11° C.) are shown in FIG. 7 and Table 8.

TABLE 8
Total IgY from conditioning at 160° F. (71.11° C.).

| | | Concentration | |
|---|---|---|---|
| Egg input | Material | (μg) | % Survival |
| Material 5 (22% rice flour) | Dry Mash | 12.19 (±3.06) | — |
| | Cooled | 7.51 (±0.77) | 62% |
| | Pellet | | |
| Material 6 (22% rice flour & | Dry Mash | 8.80 (±1.54) | — |
| 2% lignosulfonate) | Cooled | 8.69 (±1.79) | 99% |
| | Pellet | | |
| Material 7 (30% Emcap ® | Dry Mash | 19.03 (±5.61) | — |
| 06376) | Cooled | 10.75 (±2.04) | 57% |
| | Pellet | | |
| Material 8 (30% C*Gel ® | Dry Mash | 15.83 (±3.15) | — |
| 03420) | Cooled | 7.83 (±1.41) | 49% |
| | Pellet | | |

Material 6 with both rice flour and lignosulfonate continued to have the highest IgY survival ata conditioning temperature of 160° F. (71.11° C.).

Unexpectedly, addition of the pellet binder lignosulfonate, even at a low inclusion rate of 2%, had a significant effect upon IgY survival through the pelleting process at conditioning temperatures of 145° F. (62.78° C.) and 160° F. (71.11° C.).

### Example 9: Finishing Swine Diet Pellet Generation

A finishing swine diet was formulated using either Material 5 (1.40-3.35 mm granules with 22% rice flour) or Material 6 (1.40-3.35 mm granules with 22% rice flour and 2% lignosulfonate) (Table 9).

TABLE 9
Finishing swine diet formulation.

| Component | Amount (%) |
|---|---|
| Corn | 68.91% |
| Soybean Meal, Dehull, Sol Extr | 26.8% |
| Calcium carbonate | 0.85% |
| Calcium phosphate | 0.5% |
| (monocalcium) | |
| Sodium chloride | 0.5% |
| L-Lysine-HCl | 0.3% |
| DL-Methionine | 0.05% |
| L-Threonine | 0.07% |
| Trace mineral premix | 0.15% |
| Vitamin premix without phytase | 0.15% |
| Ronozyme HiPhos 2700 | 0.02% |
| Soy Oil | 1.5% |
| Egg powder (granule or spray- | 0.2% |
| dry) | |
| | 100% |

Components were mixed for 30 seconds before conditioning and pelleting. Pellets were produced from mash diets via steam conditioning (5″ (12.7 cm) diameter×36″ (91.44 cm) length) and subsequently using a pellet mill (Model CL5 California Pellet Mill Co., Crawfordsville, Ind.) equipped with a 3/16″ (0.48 cm)×½″ (1.27 cm) die. The diets were conditioned at either 175° F. (79.44° C.) or 190° F. (87.78° C.) for 30 seconds. Pellets were collected in cooling trays as they exited the pellet die and cooled with ambient air for approximately 10 minutes in a counter-flow cooler.

### Example 10: Quantification of IgY in Finishing Swine Pelleted Feed

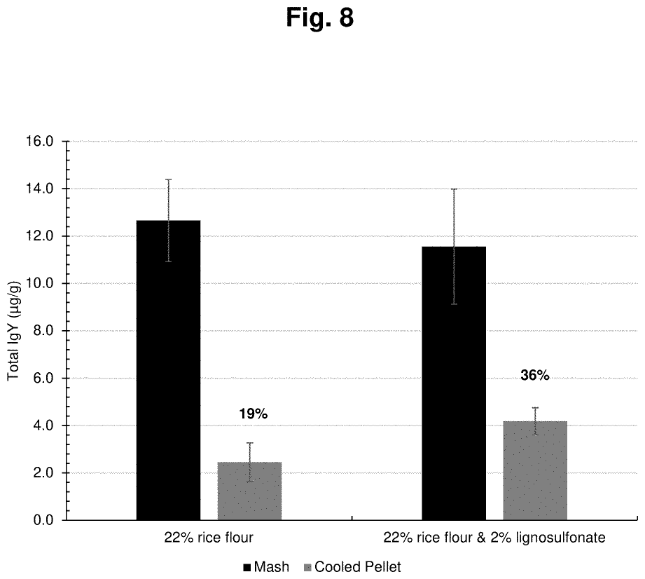

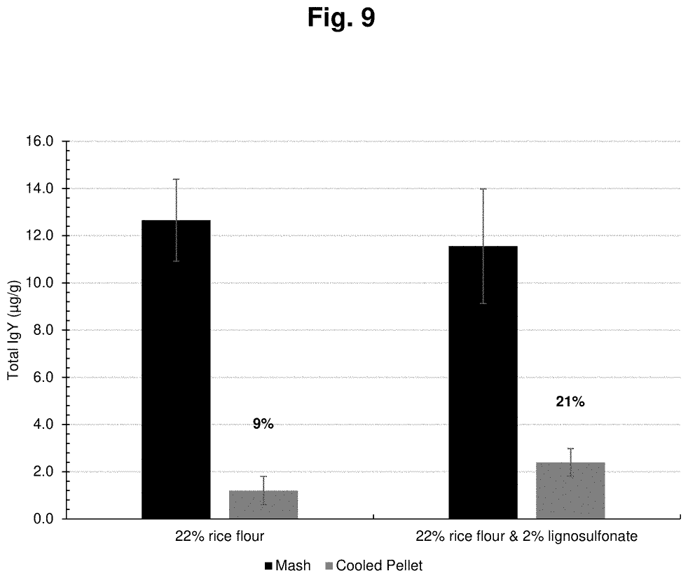

Total IgY was quantified from the feeds generated in Example 9 following the same procedures as in Example 3. The results for conditioning temperature 175° F. (79.44° C.) are shown in FIG. 8 and Table 10, and results for conditioning temperature 190° F. (87.78° C.) are shown in FIG. 9 and Table 11.

TABLE 10
Total IgY from conditioning at 175° F. (79.44° C.).

| | | Concentration | |
|---|---|---|---|
| Egg input | Material | (μg) | % Survival |
| Material 5 (22% rice flour) | Dry Mash | 12.66 (±1.74) | — |
| | Cooled | 2.46 (±0.81) | 19% |
| | Pellet | | |
| Material 6 (22% rice flour | Dry Mash | 11.55 (±2.43) | — |
| & 2% lignosulfonate) | Cooled | 4.18 (±0.57) | 36% |
| | Pellet | | |

TABLE 11
Total IgY from conditioning at 190° F. (87.78° C.).

| | | Concentration | |
|---|---|---|---|
| Egg input | Material | (μg) | % Survival |
| Material 5 (22% rice flour) | Dry Mash | 12.66 (±1.74) | — |
| | Cooled | 1.20 (±0.60) | 9% |
| | Pellet | | |
| Material 6 (22% rice flour & | Dry Mash | 11.55 (±2.43) | — |
| 2% lignosulfonate) | Cooled | 2.39 (±0.58) | 21% |
| | Pellet | | |

At the higher conditioning temperatures of 175° F. (79.44° C.) and 190° F. (87.78° C.) the amount of IgY survival is low (<50%), but the additional of lignosulfonate still conferred additional protection to the antibodies with IgY survival increasing from 19% without lignosulfonate to 36% with lignosulfonate at 175° F. (79.44° C.) and from 9% to 21% at 190° F. (87.78° C.), respectively.

Examples 8 and 10 clearly demonstrate the advantages of adding a pellet binder, specifically lignosulfonate, to the egg granules along with a starch or flour.

### Example 11: Generation of Dry Granulated Material

Three hyperimmunized spray-dried egg powders were granulated using a Fitzpatrick CCS320 Contained Compaction System following similar parameters as in Example 1:

Material 9—100% hyperimmunized spray-dried whole egg powder

Material 10—76% hyperimmunized spray-dried whole egg powder, 22% rice flour, and 2% lignosulfonate (brand name Super-Bind®)

Material 11—76% hyperimmunized spray-dried whole egg powder, 22% rice flour, and 2% gelatin by-product (brand name Protein-Plus®)

The CCS320 did not have an automated sifter/recycle apparatus, as shown in FIG. 1; instead the generated material was collected and manually sifted through a US Mesh 14 (1.40 mm) sieve to generate a fines fraction (material that passed through the sieve) and a granulated fraction (material that did not pass through the sieve). The fines fraction was passed through the CCS320 unit again to generate additional granulated material, which was again sifted. Using this method, a granulation efficiency was determined for each granulated powder by dividing the mass of the granulated fraction by the sum of the granulated fraction and the fines fraction. Table 12 summarizes the granulation efficiencies of three powders.

TABLE 12
Granulation efficiency of egg powders.

| | Granulation efficiency | |
|---|---|---|
| Egg Input | 1^{st} Pass | 2^{nd} Pass |
| Material 9 (100% egg powder) | 20% | 25% |
| Material 10 (22% rice flour and | 33% | 33% |
| 2% lignosulfonate) | | |
| Material 11 (22% rice flour and | 33% | 40% |
| 2% gelatin by-product) | | |

The hyperimmunized egg powder has poor granulation efficiency. This was improved by passing the fines through the process again, which increased the efficiency from 20% to 25%. It was also improved with additives, such as rice flour and a pellet binder. The gelatin by-product binder Protein-Plus® resulted in the highest efficiency of 40% with a second pass. While this is double from the 1^{st} pass of the egg powder by itself, it is <50%. This demonstrated an automated sifting/recycle process, as practiced in Example 1.

### Example 12: Quantification of IgY in the Granules and Input Powders

Total IgY was determined for both the input powder that was not granulated and the resulting granules for Materials 9, 10, and 11 to determine the % IgY survival through the granulation process. IgY was extracted by mixing 4 g of material (powder or granule) with 36 g of 0.2% (v/v) acetic acid, gently mixing for 1 hour at room temperature, and then held at 4° C. overnight. The next morning, the samples were mixed and centrifuged to remove the solids. The supernatant was kept and diluted with an equal volume of dilution buffer (PBS with 1% BSA, 0.05% Tween20 and 0.02% sodium azide). Total IgY was quantified using the Chicken IgY ELISA Kit (Immunology Consultants Laboratory, Inc., Portland, Oreg.) and following the manufacturer's instructions. Two dilutions were made for each sample (1:200,000 and 1:400,000) and each was run in duplicate. Concentrations are the average between all replicates and dilutions. The results of the quantification and the IgY survival is in Table 13.

TABLE 13
IgY survival through granulation process.

| | Total IgY (mg/g) | | % |
|---|---|---|---|
| Egg Input | Input Powder | Granules | Survival |
| Material 9 (100% | 12.52 (±2.21) | 11.65 (±1.30) | 93.1% |
| egg powder) | | | |
| Material 10 (22% | 5.66 (±1.19) | 5.18 (±1.04) | 91.6% |
| rice flour and | | | |
| 2% lignosulfonate) | | | |
| Material 11 (22% | 9.24 (±2.21) | 8.28 (±1.68) | 89.6% |
| rice flour and 2% | | | |
| gelatin by-product) | | | |

All three materials had ˜90% IgY survival through the granulation process. The 10% loss of IgY is likely from the compaction of the material and small temperature elevations from friction during processing.

### Example 13: Generation of Dry Granulated Material

Hyperimmunized spray-dried powder will be dry granulated following the same procedure from Example 1. A possible composition would be 50% hyperimmunized spray-dried whole egg powder, 24% rice flour, 24% potato starch, and 2% Protein-Plus®, but other compositions could be generated consisting of different flours/starches, other saccharides, other fat-containing additives or a different pellet binder.

### Example 14: Generation of Phase I Swine Diet Pellets

The granules produced in Example 13 will be formulated into an early-stage swine diet (i.e., Phase I) as described in Example 2. Two conditioning temperatures will be used: 145° F. (62.78° C.) and 160° F. (71.11° C.).

### Example 15: Quantification of IgY in Phase I Pelleted Feed

Total IgY will be quantified from the feeds generated in Example 14 following the same procedures in Example 3. The IgY concentration in the pelleted feed will be divided by the IgY concentration in the starting mash to calculate the IgY survivability during the pelletization process.

### Example 16: Swine Feeding Trial

The optimized granulation composition, as used in Example 13, will be used to generate Phase I feed pellets (as in Example 2) at 0.1% and 0.2% inclusion levels of the granulated hyperimmunized egg product at 145° F. (62.78° C.) to be used in a feeding trial.

A minimum of 280 newly weaned pigs with initial body weights of approximately 12 lbs (˜0.907 kg) will be used in a 35-day growth trial. Pigs will be housed in 4×4 ft. (1.23×1.23 m) pens containing a three-hole dry self-feeder and one cup waterer to provide ad libitum access to feed and water. Pigs will be weaned at approximately 21 d of age. Upon arrival at the research facility, pigs will be weighed and assigned to pens in a completely randomized design. There will be 5 pigs per pen and a minimum of 8 replications per treatment. Three treatments will be fed: Control (no hyperimmunized egg), Control +0.2% hyperimmunized egg, and Control +0.4% hyperimmunized egg. Diets will be fed in two phases with Phase I (pelleted) fed for the first 7 days after placement and Phase II (meal containing no hyperimmunized egg) fed from day 7 to 21. A common corn/SBM diet (meal) will be fed from day 21 to 35 to all pens. Diets will be formulated to be reflective of those used in commercial production with nutrient levels set to meet or exceed the NRC (2012) nutrient recommendations.

Pigs will be weighed and feed disappearance recorded on days 0, 7, 14, 21, 28, and 35 of experiment to determine growth performance (average daily gain (ADG), average daily feed intake (ADFI), and feed/gain ratio (F/G)). Feed additions will be recorded for each individual pen. Feed samples will be collected at manufacturing and from feeders at the beginning and before completion of the trial. Composite samples will be kept refrigerated at the KSU Swine Lab for storage until analysis. Complete diet samples will be sent for proximate analysis. There will be no in-feed antimicrobials used in any treatments during any point of the trial. Any antibiotics utilized for health reasons will be given by individual injection. Animal care will be performed on a daily basis. Under the circumstance where a pig requires treatment, the date, reason for treatment, medication, and dose shall be recorded. Under the circumstance where a pig dies or needs to be removed from the study due to inability to overcome sickness or injury, the weight of the pig and feed consumption up until that date shall be recorded. Notes detailing suspected cause of death or reason for removal shall also be documented. Experimental data will be analyzed with pen serving as the experimental unit. Treatment differences will be considered significant at P≤0.05 and marginally significant at 0.05<P≤0.10. The goal will be to demonstrate improved performance with the hyperimmunized egg product in the pelleted feed (e.g., higher weight gain, lower morbidity/mortality, etc.)

### Example 17: Poultry Feeding Trial

Twenty-one chickens will be randomly assigned to one of seven groups (three birds in each group) and placed in separate cages. Each group will be fed a different mash diet: Control (no egg powder), 0.1% spray-dried hyperimmunized egg powder, 0.2% spray-dried hyperimmunized egg powder, 0.4% spray-dried hyperimmunized egg powder, 0.1% granulated hyperimmunized egg powder, 0.2% granulated hyperimmunized egg powder, and 0.4% granulated hyperimmunized egg powder. Water and feed will be provided ad libitum to the birds. On day 3, all birds will be sacrificed, and the contents of both their ceca will be collected.

### Example 18: Quantification of IgY in Cecal Contents

IgY will be extracted from the cecal contents collected in Example 17 by mixing 0.5 g of the cecal material with 2 g of 0.2% acetic acid and incubating overnight at 4° C. (at least 16 hours). The next morning, the samples will be centrifuged to remove any solids, and the supernatant will be used to quantify the total IgY using the Chicken IgY ELISA Kit (Immunology Consultants Laboratory, Inc., Portland, Oreg.) and following the manufacturer's instructions. Three dilutions will be made for each sample (1:10, 1:20, and 1:40) and each run in duplicate. The IgY concentrations will be compared to determine if the granulated hyperimmunized egg could reach the cecum as evidenced by higher IgY concentrations compared to the control-fed birds and spray-dried egg powder-fed birds.

We claim:

1. A method of producing egg granules comprising:
(a) spray drying an egg comprising one or more antibodies to produce a low moisture egg powder; and
(b) dry granulating the low moisture egg powder to produce egg granules comprising the one or more antibodies.

2. The method of claim 1, wherein the egg is a hyperimmunized egg.

3. The method of claim 1, wherein the egg is an avian egg.

4. The method of claim 1, wherein the one or more antibodies are IgY antibodies.

5. The method of claim 1, comprising after step (a) and before step (b) the additional step of adding one or more additives to the low moisture egg powder.

6. The method of claim 5, wherein the one or more additives is one or more saccharides, one or more fat-containing additives, and/or one or more binding agents.

7. The method of claim 6, wherein the one or more saccharides is a disaccharide, a flour, or a starch.

8. The method of claim 7, wherein the flour or starch is derived from wheat, rice, potato, corn, tapioca, barley, oat, or a combination thereof.

9. The method of claim 1, wherein the egg granules have a diameter in a range of about 0.70 mm to about 5.00 mm, about 1.40 mm to about 3.35 mm, or about 2.00 mm to about 3.35 mm.

10. The method of claim 1, wherein the dry granulation of step (b) comprises the steps of:
(i) mixing components;
(ii) compacting components through a roller or under pressure;
(iii) milling the resulting compacted mass to form granules; and
(iv) screening the granules for size.

11. A food comprising egg granules produced by the method of claim 1.

12. An egg granule having a diameter in a range of about 0.70 mm to about 5.00 mm, wherein the egg granule comprises one or more antibodies.

13. The egg granule of claim 12, wherein the egg granule comprises hyperimmunized egg.

14. The egg granule of claim 12, wherein the egg granule comprises avian egg.

15. The egg granule of claim 12, wherein the one or more antibodies are IgY antibodies.

16. The egg granule of claim 12, wherein the egg granules have a diameter in a range of about 1.40 mm to about 3.35 mm or about 2.00 mm to about 4.75 mm.

17. The egg granule of claim 12, wherein the egg granule further comprises one or more saccharides, one or more fat-containing additives, and/or one or more binding agents.

18. The egg granule of claim 17, wherein the one or more saccharides is a flour or a starch.

19. The method of claim 18, wherein the flour or starch is derived from wheat, rice, potato, corn, tapioca, barley, oat, or a combination thereof.

20. A food comprising the egg granule of claim 12.
